(19) United States
(12) Patent Application Publication
(10) Pub. No.: US 2007/0095181 A1
(43) Pub. Date: May 3, 2007

(54) Die with Counter, Systems and Processes

(76) Inventor: Gary S. Levene, Kitchener (CA)

Correspondence Address: BERESKIN AND PARR, 40 KING STREET WEST, BOX 401, TORONTO, ON, M5H 3Y2, CA

(21) Appl. No.: 11/553,769

(22) Filed: Oct. 27, 2006

Related U.S. Application Data
(60) Provisional application No. 60/730,848, filed on Oct. 28, 2005.

(51) Int. Cl. B26D 7/27

(52) U.S. Cl. 83/13; 83/522.27

(57) ABSTRACT

A die has a counter configured to advance a count as the die is used to cut material. The output of the counter, or the variance of the count over a period of time, is used to determine the extent of use of the die over a period to time, for example a number of times that the die has been used or a value related to the cumulative thickness of material cut. A contractual consequence, such as a value to be paid for the use of the die or a warranty provision, may be determined considering the extent of use of the die. A system for using such a die may include a polling element and a computing element.

This is an application claiming the benefit under 35 USC 119(e) of U.S. Application Ser. No. 60/730,848 filed Oct. 28, 2005. U.S. Application Ser. No. 60/730,848 is incorporated herein, in its entirety, by this reference to it.

### FIELD

This specification relates to die cutting.

### INTRODUCTION

In die cutting, one or more dies may be placed in contact with one or more sheets of material in a press. When the press is closed, the die cavities cut the material into desired shapes. In some cases, companies that manufacture dies sell dies, individually or in groups attached to a board, to cutting companies that use the dies to produce cut pieces of material.

### SUMMARY

The following summary is intended to introduce the reader to this disclosure but is not intended to define or limit any claimed or disclosed invention. This specification may describe one or more inventions which may reside in a combination or sub-combination of steps or elements provided in this or other parts of this document, for example in the claims.

A die may comprise a length of rule formed so as to define a cavity or the perimeter of a shape or pattern to be cut in one or more sheets of material. A counter may be attached to the die. The counter may have an actuator and be located or configured to advance the counter one or more times when the die is used to cut a material. For example, as a press pushes the die and material together, the actuator may contact and be moved by the material or a part of the press and the count may be advanced to record the increase in extent of use of the die. The counter may be chosen and located such that each cut, or movement of the press, advances a count by one. Alternately, the counter may be chosen and located such that the count advances by an amount related to the increase in cumulative thickness of material cut. Optionally, a second or multiple counters may be used which are chosen or located to each provide a count related to a different aspect of the use of a die. The counts, or the set of counts, of the one or more counters, optionally when compared to an initial count or sum of counts, indicates the extent of use of the die over a period of time.

A method of determining the extent of use of a die by a user may comprise steps of providing a die as described above to a user, and after a period of time, calculating a difference in the reading of the counter before and after the period of time.

A method of determining a contractual consequence related to the use of a die, such as an extent of coverage under a warranty or an amount to be paid for the use of a die, may comprise steps described above and a step of considering the count in determining the contractual consequence.

A system for determining a value related to the use of a die, such as an amount to be paid for the use of a die or coverage under a warranty, may comprise a die as described above, a polling element for polling the one or more counters to determine an extent of use of the die and a computation element adapted to convert the extent of use into a value related to the use of a die, for example an amount to be paid or to a parameter related to an amount to be paid or a usage amount for use in determining coverage under a warranty.

### BRIEF DESCRIPTION OF THE FIGURES

FIGS. 1 and 2 are photographs of a die with a counter.

FIG. 3 is a schematic representation of a system having a die as shown in FIGS. 1 and 2.

FIG. 4 is a schematic representation of a process for determining the number of uses of a die and a value related to the amount to be paid for use of the die.

FIG. 5 is a schematic representation of an alternate counter.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

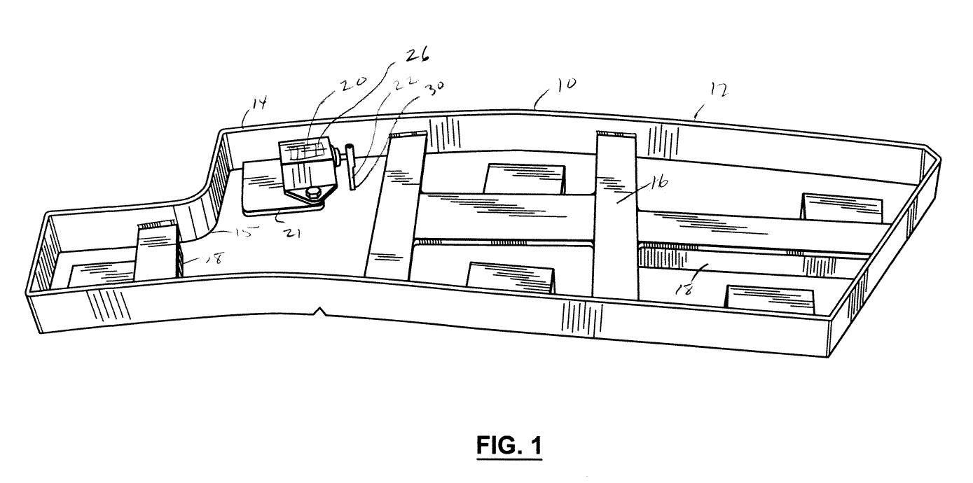

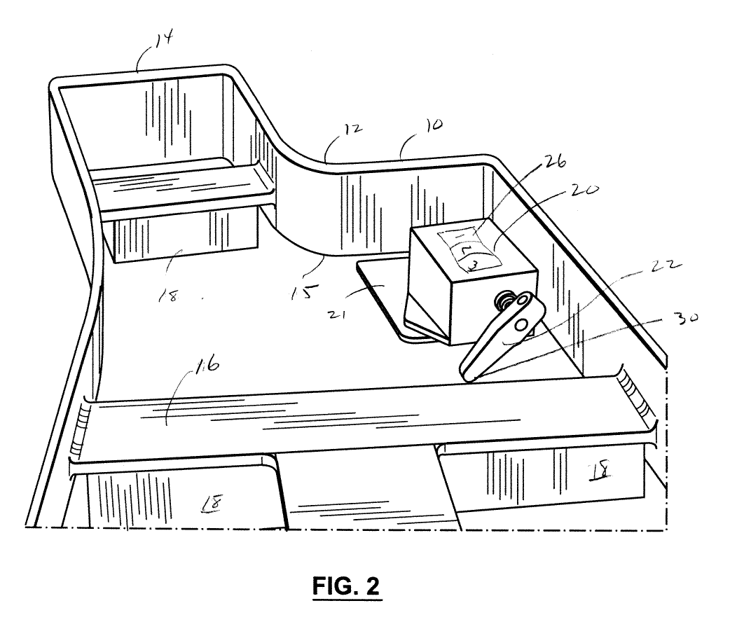

FIGS. 1 and 2 show a die 10. Die 10 is of a type used to cut pieces of automobile upholstery from leather. However, other types of dies may be made or used. For example, but without limitation, the die may be a cavity die with or without braces fitted into a slot in a die board, a die attached by fasteners, for example through a brace, to a die board or a free standing die used without a die board, such as a die of the type arranged by hand over a leather hide. Die 10 comprises a length of rule 12 having a bearing edge 14 and a cutting edge 15. The die 10 also has brace 16 spanning the cavity. Foam 18 may be attached to the brace 16 or otherwise provided in the cavity. In use, the die 10 may be placed in a press. The bearing edge 14 is positioned to contact a plate, pad, roller or related structure on one side of the press. Material to be cut is placed between the cutting edge 15 and a plate pad, roller or related structure on another side of the press. Operation of the press causes the material to be pushed into the cavity and around the outside of the die 10.

A counter 20 is attached to the die 10. In the embodiment shown, a plate 21 is welded to rule 12 and counter 20 is fastened to plate 21 although other attachment mechanisms may be used. The counter 20 may be, for example, a mechanical stroke counter which advances a count by one for each movement of its actuator that exceeds a minimum length. Such a counter 20 may operate by depressing a pin or by moving the tip of a lever, as in a rotary ratchet counter. The counter 20 is chosen and placed related to the cutting edge of the die 10 so that the actuator will be moved in excess of the minimum length when the minimum expected thickness of one or more sheets of material advances past the cutting edge of the die 10 during a cut, accounting for compression of the material if necessary given the material, the structure of the die 10, the force required to move the actuator and any foam inserts in the die 10.

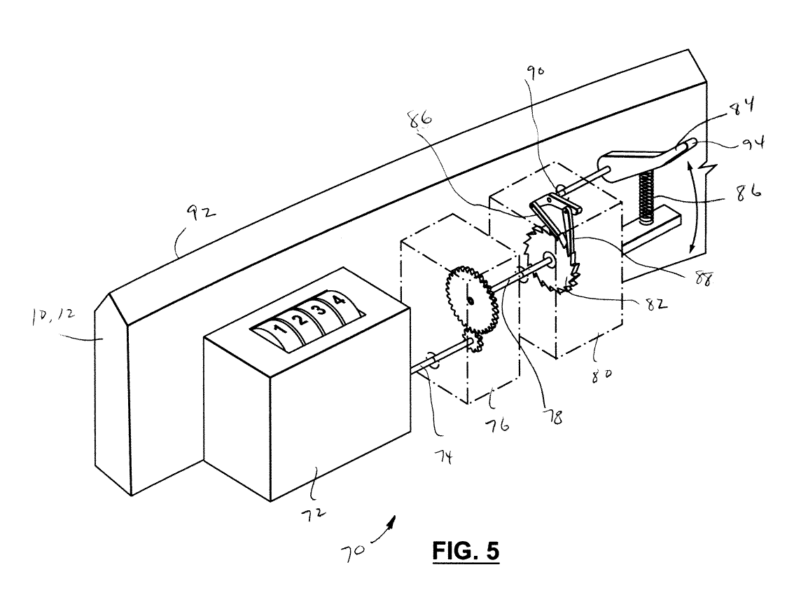

Optionally, other types of counters may be used such as a rotary counter or a counter that produces a count related to the cumulative length or angle of movement of an actuator. A second counter 70, shown in FIG. 5, has a rotary counter 72, a gear box 76, a ratchet 80, an actuator 84 and a spring 86. Rotary counter 72 records, by counting, the cumulative number of rotations, or fractions of a rotation, of its shaft 74. Gear box 76 is optional but causes the shaft 74 of the rotary counter 72 to move by a multiple of the degrees of rotation of a gear box shaft 78 to increase the sensitivity of second counter 70 if required. Ratchet box 80 converts rotary reciprocating motion of ratchet box shaft 90 into possibly intermittent but forward only rotation of gear box shaft 78 or rotary counter shaft 74. Gear box 80 as shown has a ratchet wheel 82 and first and second pawls 86, 88 arranged so that notched wheel 82 rotates forward with both the forward and backward rotation of ratchet box shaft 90. This increases the sensitivity of second counter 70, but a ratchet mechanism that moves forward only on forward rotation of an input shaft can also be used. Actuator arm 84 is attached to ratchet box shaft 90 and positioned so that movement of cut material past the cutting edge 92 of die 10 rotates ratchet box shaft 80. For example, the tip 94 of actuator arm 84 may have an initial or at rest position in or near the same plane as the cutting edge 92 or below that plane by a distance less than the expected thickness of material to be cut. Spring 86 returns actuator arm 84 to the initial position between cuts. Gear box 76, ratchet box 80 and spring 86 may be located in the body of rotary counter 72, and their individual outer boxes may be omitted. These components may also be moved relative to each other. For example, gear box 76 may be placed between ratchet box 80 and actuator arm 84. Ratchet wheel 82 is shown in FIG. 5 as having a large distance between adjacent teeth for purposes of illustration. A shorter distance between a greater number of teeth and corresponding changes to pawls 86, 88 is preferable to increase the sensitivity of second counter 70. When a stack of material is cut, the shaft 74 of rotary counter 72 is rotated by displacement of the end 94 of actuator arm 84 by an angle that reflects the extent of usage of the die by being related or proportional to the increase cumulative thickness of material cut. Cutting a stack of material of small thickness creates a small rotation of rotary counter shaft 74 whereas cutting a thick stack of material causes a greater rotation. Each cut increases the cumulative rotation of rotary counter shaft 74, which advances the count, by an amount related to the thickness of the stack of material cut. The count, or change in count over time, may be greater or less than the number of cuts made but is instead related to the cumulative thickness of material cut. Wear of a die 10 is related to the number of cuts and the total thickness of material cut and so either, or both, measures of extent of use may be useful.

Other counters 20 may also be used. For example, but without limitation, the counter 20 may be electronic or may be activated by a light sensor, closure of an electrical circuit or other means. The counter may have a transmitter to communicate its count over a communications network, for example, continuously, at discrete time intervals, or when polled. The counter 20 shown in FIGS. 1 and 2 is a mechanical counter triggered by movement of an actuator 22, specifically a ZGDHDO model J55C counter. Operation of the press causes the material to contact and move the actuator 22 to advance the counter 20. The counter 20 shown has a display 26 in the form of cylinders printed with the numbers 0 to 9 and placed to correspond with the representation of a base 10 number. The counter 20 may optionally have a reset button to index the counter display 26 to show a count of 0. The reset button may be in the form of a removable key to inhibit the user from resetting the counter 20 to 0. Alternately, counter 20 may have no reset capability or have other methods of resetting or indexing or communicating a value. For example, but without limitation, a counter 20, with or without a reset capability, may be indexed by noting or transmitting its value at a point in time and may communicate its count by electronic transmission of a signal representing a value or visual display of a signal representing a value. Where multiple dies 10 are attached to a die board, one or more of the dies 10 may have an associated counter 20.

The actuator 22 in the counter 20 shown in FIGS. 1 and 2 is an arm having a tip 30 located so as to contact the material being cut as the die 10 moves through the material. As the material is being cut, movement of the tip 30 rotates the actuator 22 and advances the count shown on the display 26. In this way, the counter 10 counts the number of times that the die 10 has been used to cut material, this number of cuts or uses being the number of times that the die 10 is pressed, regardless of the number of sheets of material in the die during each cut. The number of times that the die 10 has been used in a period of time is indicated by the difference between a count shown on the display 26 after the period of time and a count shown on the display before the period of time. If the counter 20 has been indexed to 0 before cutting by pushing the reset button, this difference can be determined by noting the number displayed on the counter 20 after use of the die 10. Similar methods may be applied to the second counter 70 of FIG. 5 to determine a change in count over time.

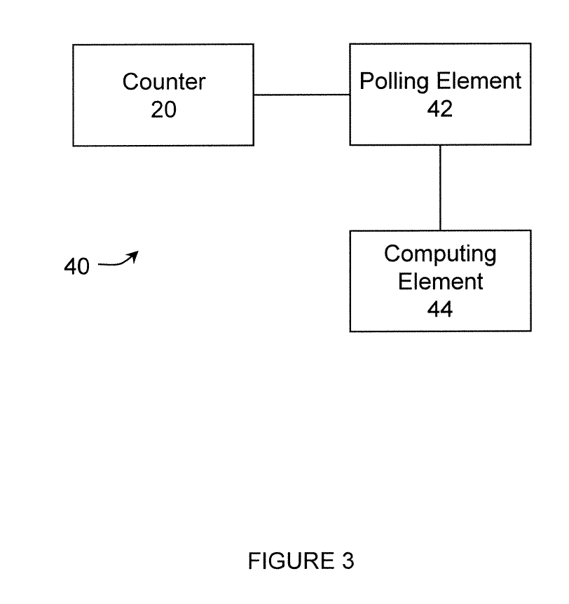

FIG. 3 shows a system 40 for determining an amount to be charged for the use of a die 10. The system 40 comprises a counter 20, a polling element 42 and a computing element 44. The polling element 42 in the system 40 shown is a person that looks at the counter 20 of the die 10 and notes the count displayed. The computing element 44 is a person, who may be the same person as the polling element 42, who calculates a value related to an amount to be paid considering the displayed count. Other polling elements 42 and computing elements 44 may be used. For example, but without limitation, the polling element 42 may be a sensor or signal processor which may be linked by a communication apparatus to the computing element 44. The computing element may be a processor programmed to convert the displayed count, optionally with other information, into an amount to be paid or a value related to an amount to be paid. The value related to an amount to be paid may be, for example but without limitation, a value indicating an amount to be paid for a part of a billing period or a base value to which taxes, currency exchange factors, mark ups or other modifications are applied. Other information which the computing element may consider could include a multiple selected to convert a number of uses into a base payment amount, a formula modifying the multiplier, for example to provide a volume discount or other variation in the multiplier, or price discounting or price inflating factors, for example an inflation factor.

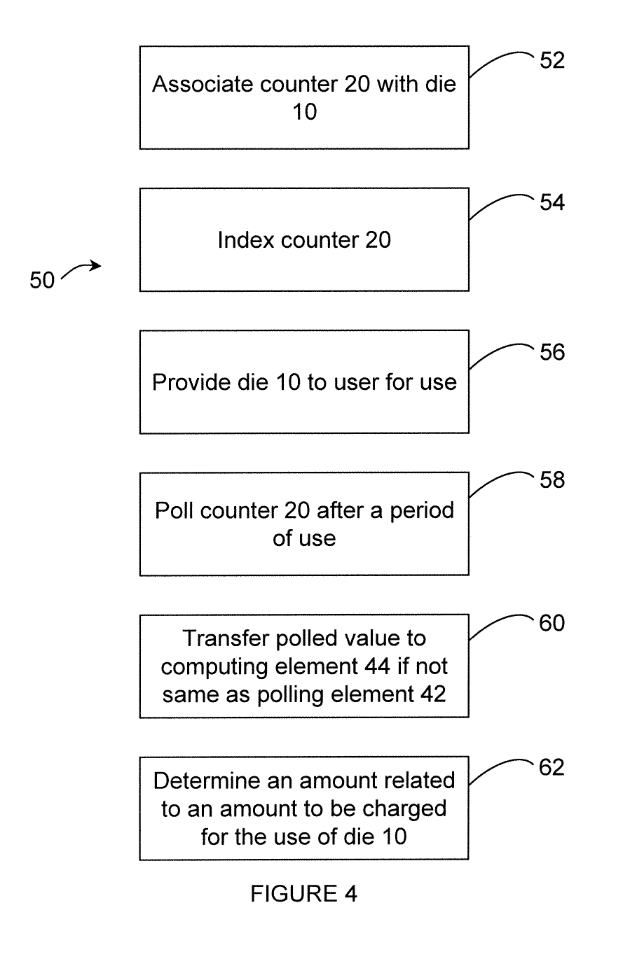

FIG. 4 shows a method 50 of determining the number of uses of a die 10 or an amount to be paid for the use of a die 10. In step 52 counter 20 is associated with a die 10, for example by attaching the counter 20 to the die 10 such that the counter 20 will advance its count when the die 10 is used. In step 54, the counter is indexed, for example by pushing a reset button to set the display to a base value, for example 0, or by noting the displayed value. In step 56, the die 10 is provided to a user for use in cutting material. Optionally, steps 54 and 56 may be performed in reverse order. In step 58, the counter 20 is polled to determine a count after a period of use. The polling may occur, for example, by visual inspection of the counter 20, by electronic interrogation of the counter 20 or by configuring the counter 20 to automatically poll itself at time intervals or a sampling rate. In step 60, the polled value is transferred to a computing element or to a location accessible to a computing element. In step 62, an amount related to the amount to be charged for use of the die is determined. These steps, for example steps 58-62, may be performed manually or some may be performed electronically. For example, in step 58, an employee of the die maker may look at the die and note the count. For step 60, the employee may tell the count to a contracts administrator. In step 62, the contracts administrator may subtract a non-zero start count, if any, from the count to determine the number of times the die 10 has been used. The account administrator may then multiply the number of uses by an amount per use and apply any other adjustment factors according to an agreement between the die maker and the user. Various steps, for example steps 58 and 60 or 54, 58, 60 and 62 or 58, 60 and 62, may be repeated in contracts in which a use of the die 10 continues after an amount is billed for use of the die 10 in a preceding period of time.

In either of the system or method or FIG. 3 or 4, the count may alternately correspond extent of use of the die 10 other than by reflecting the number of cuts. For example, where a counter is used that may advance its count in relation to cumulative thickness of material cut, an amount to pay for use of the die may be based on that count instead or on multiple counts reflecting the number of uses and cumulative thickness cut.

Values related to the extent of use of the die may also be used for other purposes or to determine the contractual consequences. For example the count could be used to keep track of a warranty period. A warranty period may have varying conditions, such as a replacement value, that would apply depending on the number of times the die has been used, cumulative thickness cut, or other value reflected by the count. For example, the warranty may provide for free replacement within the first 1,000 counts, replacement at half of the original cost during the next 1,000 counts and no replacement thereafter.

The embodiments described above give examples of the invention but do not limit the scope of the invention and the invention may be practiced with alternate apparatus elements or with alternate method steps.

We claim:

1. A cutting apparatus comprising:
a) a length of rule; and,
b) a counter attached to the rule.

2. The cutting apparatus of claim 1 wherein the counter has an actuator and is located and configured to advance a count by one upon movement of the actuator below a cutting edge of the length of rule by a distance at least as great as an expected depth of material to be cut by the die.

3. The cutting apparatus of claim 1 having no re-set function or a limited access reset function.

4. The cutting apparatus of claim 1 wherein the counter is located and configured to advance a count upon movement of the actuator by an amount related to the distance of intrusion of material past the cutting edge of the length of rule.

5. A method of determining the extent of use of a die comprising the steps of attaching a counter to a die and considering the count of the counter after a period of use.

6. The method of claim 5 wherein the extent of use is a number of pressings.

7. The method of claim 5 wherein the extent of use is related to a cumulative thickness of material cut.

8. The method of claim 5 further comprising a step of considering the count to determine a contractual consequence related to the extent of use of the die.

9. The method of claim 8 wherein the contractual consequence is an amount to be paid for the use of the die.

10. The method of claim 8 wherein the contractual consequence is an amount to be paid under a warranty.

11. A system for determining a contractual consequence related to use of a die comprising a counter associated with the die, a polling element and a computing element.

12. The system of claim 11 further comprising a communications network.

13. The system of claim 11 wherein the computing element comprises a computer.

14. The system of claim 11 wherein the polling element comprises a transmitter to transmit a signal related to the count of the counter and a receiver to receive the signal.
